(19) United States
(12) Patent Application Publication
(10) Pub. No.: US 2018/0261960 A1
(43) Pub. Date: Sep. 13, 2018

(54) SHIELD CONNECTOR AND MANUFACTURING METHOD THEREFOR

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventors: Tetsuya Miyamura, Yokkaichi, Mie (JP); Hiroki Hirai, Yokkaichi, Mie (JP); Yasuo Omori, Yokkaichi, Mie (JP)

(21) Appl. No.: 15/750,216

(22) PCT Filed: Jul. 22, 2016
(86) PCT No.: PCT/JP2016/071630

§ 371 Date: Feb. 5, 2018

(30) Foreign Application Priority Data
Aug. 7, 2015 (JP) 2015-156827

(51) Int. Cl. H01R 13/6463; H01R 13/6581; H01R 9/03

(52) U.S. Cl. CPC H01R 13/6463; H01R 9/035; H01R 9/038; H01R 13/6581

(57) ABSTRACT

The shield connector (C1) includes terminals (10) having at least one terminal to be shielded, an insulating housing (20), and a shielding sheet (30) to be mounted on the terminal to be shielded to cover a sheet mounting surface set for at least a part of a surface of the terminal to be shielded excluding a part to be brought into contact with a mating terminal. The shielding sheet (30) includes an insulating layer (32) and a conductive layer (34), is mounted on the terminal to be shielded with the insulating layer (32) held in close contact with the sheet mounting surface, and has flexibility to be laid in conformity with an outer shape of the sheet mounting surface. The terminal to be shielded (10) is accommodated in a terminal accommodating portion (22) of the housing (20) with the sheet mounting surface covered by the shielding sheet (30).

### BACKGROUND

### Field of the Invention

The invention relates to a shield connector used in connecting a twisted pair cable or the like and a manufacturing method therefor.

### Description of the Related Art

Conventionally, a twisted pair cable is known as a wire having excellent resistance against the penetration of noise from outside due to electromagnetic waves. This twisted pair cable includes two wires twisted with each other. A high-potential signal and a low-potential signal are caused to flow in these wires, and necessary information is transmitted by a potential difference between the signals. In this twisted pair cable, even if noise is mixed into each wire, the potential difference between the wires is kept substantially constant by making a voltage of each noise substantially equal. Thus, the influence of the noise on the information to be transmitted is small.

The twisted pair cable exhibits shielding in an area where the wires are twisted. However, ends of the wires where terminals have to be mounted need to be untwisted and, therefore, it is difficult to ensure high noise resistance at these ends.

Japanese Unexamined Patent Publication No. 2012-226832 discloses a shield connector for connecting an end of a twisted pair cable to another wire or the like while shielding the end of the twisted pair cable. This shield connector includes terminals to be crimped to ends of respective wires, insulating housings for individually accommodating the terminals and a shield shell for collectively surrounding the insulating housings. The shield shell is connected to a drain.

However, the shield connector described in Japanese Unexamined Patent Publication No. 2012-226832 requires the shield shell of a size to collectively surround the insulating housings in addition to the insulating housings for respectively holding the terminals. Thus, the enlargement of the entire connector is unavoidable. A problem of the enlargement of the shield shell and the entire connector including the shield shell becomes a more serious problem as the number of the terminals increases. Further, this problem similarly occurs in connectors for electromagnetically shielding wires other than twisted pair cables.

The invention aims to provide a shield connector capable of providing necessary electromagnetic shielding without causing the enlargement of the entire connector and a manufacturing method therefor.

### SUMMARY

A shield connector is provided and has an electromagnetic shielding function of shielding noise caused by electromagnetic waves from outside. The shield connector includes terminals to be mounted respectively on ends of wires. The terminal include at least one terminal to be shielded. The shield connector also has an insulating housing made of an insulating material and including terminal accommodating portions for respectively accommodating and holding the terminals. A shielding sheet to be mounted on the terminal to be shielded to cover a sheet mounting surface set for at least a part of a surface of the terminal to be shielded excluding a part to be brought into contact with a mating terminal. The shielding sheet has an electromagnetic shielding function. The shielding sheet includes an insulating layer made of an insulating material and a conductive layer made of an electrically conductive material and to be laminated on the insulating layer. The shielding sheet is mounted on the terminal to be shielded with the insulating layer held in close contact with the sheet mounting surface and has flexibility to be laid in conformity with an outer shape of the sheet mounting surface. The terminal to be shielded is accommodated and held in the terminal accommodating portion with the sheet mounting surface covered by the shielding sheet.

According to this shield connector, the shielding sheet is mounted on the terminal to be shielded to cover the sheet mounting surface with the insulating layer of the shielding sheet held in contact with the sheet mounting surface, which is a specific surface of the terminal to be shielded, thereby constructing a shielding structure in which the conductive layer is arranged on the sheet mounting surface via the insulating layer. In addition, since the shielding sheet has flexibility to be laid in conformity with the outer shape of the sheet mounting surface, the terminal to be shielded can be accommodated and held in the terminal accommodating portion of the insulating housing with the shielding sheet mounted thereon. Thus, unlike conventional shield connectors in which a shielding layer is provided on an insulating housing, the enlargement of the entire connector is not caused.

Further, since the shielding sheet is for individually covering the terminal to be shielded, the shielding sheet can be mounted, i.e. used only on the terminal to be shielded if the terminals include the at least one terminal to be shielded and the terminals other than the terminal to be shielded. This can prevent the shielding sheet from being wastefully used, thereby enabling necessary electromagnetic shielding to be provided while the amount of the shielding sheet used is reduced, unlike conventional shield connectors in which an insulating housing for holding terminals needs to be covered with a shielding layer regardless of whether the terminals include terminals other than terminals to be shielded.

The structure for connecting the terminal to be shielded and the wire is not particularly limited. The terminal to be shielded may include a wire crimping portion to be crimped to the end of the wire.

The terminal to be shielded may be a female terminal including a female electrical contact portion for receiving an electrical contact portion of a mating male terminal fit therein. In this case, since the outer surface of the female electrical contact portion does not contribute to electrical contact with the mating terminal, the outer surface can be a sheet mounting surface. This enables a fit part of the terminals to be electromagnetically shielded. Further, by setting the sheet mounting surface over the entire length of the female terminal including this electrical contact portion, the electromagnetic shielding effect is enhanced further.

The at least one terminal to be shielded is particularly effective when including terminals to be mounted on ends of wires of a twisted pair cable. In this twisted pair cable, the wires are untwisted at an end of this twisted pair cable, whereby the influence of noise at this end increases, but high noise resistance can be ensured in an area from the twisted pair cable to the terminals to be shielded by covering the terminals to be shielded mounted on the ends of these wires by the shielding sheets.

A method also is provided for manufacturing a shield connector having an electromagnetic shielding function of shielding noise caused by electromagnetic waves from outside. The method includes a step of preparing terminals including at least one terminal to be shielded and an insulating housing having terminal accommodating portions for accommodating and holding the terminals. The method includes mounting the terminals on ends of wires, and mounting a shielding sheet having the electromagnetic shielding function on the terminal to be shielded to cover a sheet mounting surface set for at least a part of a surface of the terminal to be shielded excluding a part to be brought into contact with a mating terminal. The shielding sheet includes an insulating layer made of an insulating material and a conductive layer made of a conductive material and to be laminated on the insulating layer. The shielding sheet has flexibility to be laid in conformity with an outer shape of the sheet mounting surface and is mounted on the terminal to be shielded with the insulating layer held in close contact with the sheet mounting surface. The method further includes inserting and holding the terminals in the terminal accommodating portions of the housing with the sheet mounting surface of the terminal to be shielded covered by the shielding sheet.

According to this method, the shield connector having an effective electromagnetic shielding function as described above can be manufactured by a simple configuration of adding the step of mounting the shielding sheet for covering the sheet mounting surface on the terminal to be shielded, out of the plurality of terminals, in addition to steps included in a usual manufacturing method for connector.

### BRIEF DESCRIPTION OF DRAWINGS

FIG. 1 is an exploded perspective view of a shield connector according to an embodiment of the present invention.

FIG. 2 is a front view in section of the shield connector.

FIG. 3 is a side view showing an area of a terminal to be shielded included in the shield connector where a shielding sheet is to be mounted.

FIG. 4 is a perspective view showing the terminal to be shielded and the shielding sheet to be mounted on this terminal.

FIG. 5 is a perspective view showing the terminal to be shielded mounted with the shielding sheet.

FIG. 6 is a front view in section showing the terminal to be shielded and the shielding sheet to be mounted on this terminal.

### DETAILED DESCRIPTION

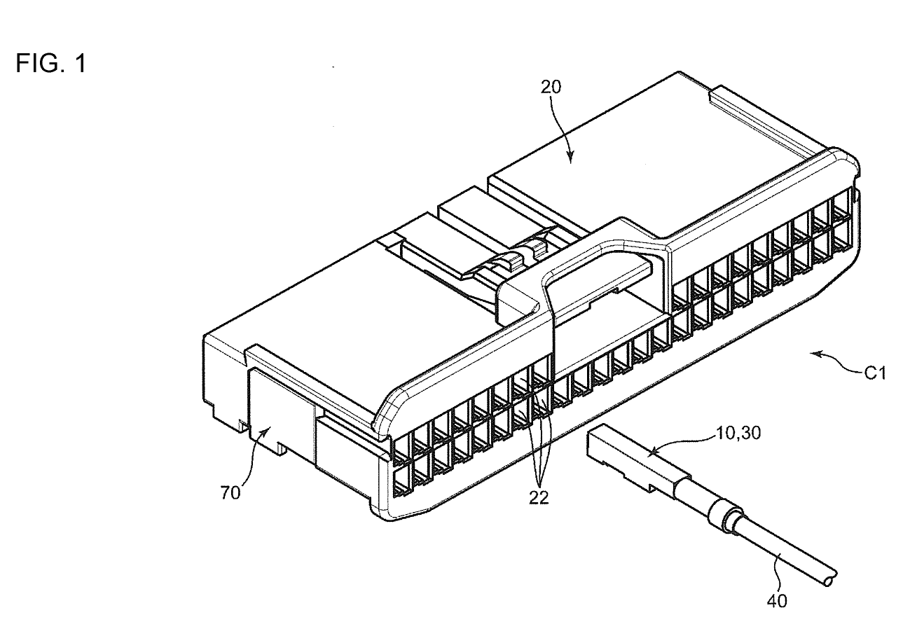

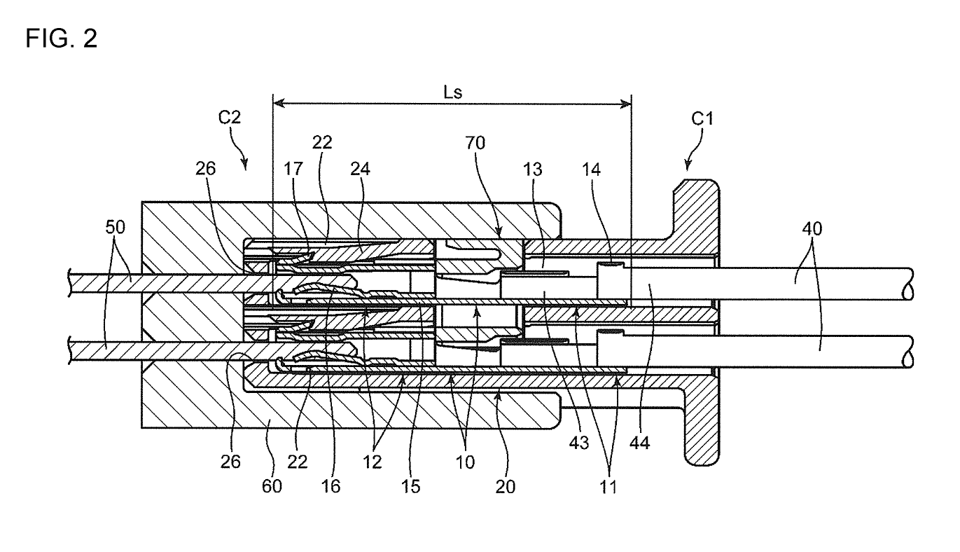

FIGS. 1 and 2 show a shield connector C1 according to the embodiment of the invention. The shield connector C1 according to this embodiment is a female connector and establishes electrical connection by being connected to a male mating connector C2 shown in FIG. 2. Specifically, this shield connector C1 includes female terminals 10 including terminals to be shielded, an insulating housing 20 for accommodating and holding the female terminals 10 and shielding sheets 30 to be mounted on each of the terminals to be shielded.

The female terminals 10 are mounted respectively on ends of wires 40. The terminals to be shielded require electromagnetic shielding and are mounted on at least two of the wires that are twisted with each other to constitute one twisted pair cable. In other words, the electrical connection formed by the shield connector C1 and the mating connector C2 includes the connection of at least one twisted pair cable and another circuit, and the terminals to be shielded are mounted on the ends of the wires untwisted at an end of the at least one twisted pair cable.

FIG. 1 shows only one female terminal 10 to be shielded in the shield connector C1. The female terminals 10 other than those equivalent to this terminal to be shielded also are shaped and structured similarly.

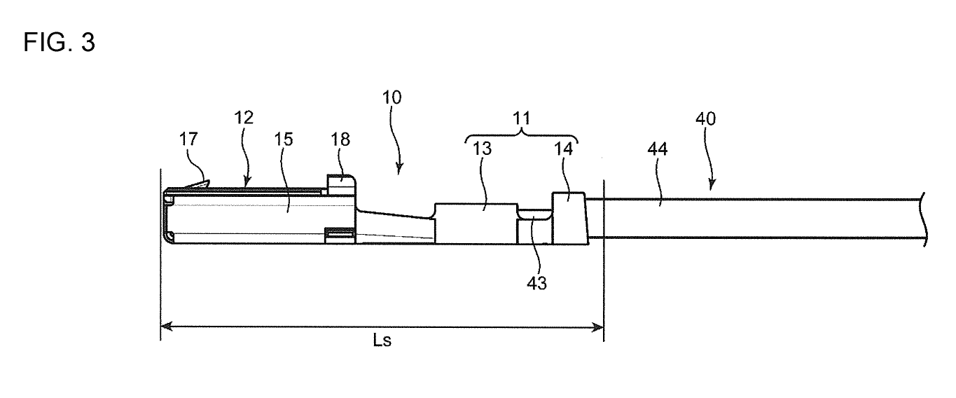

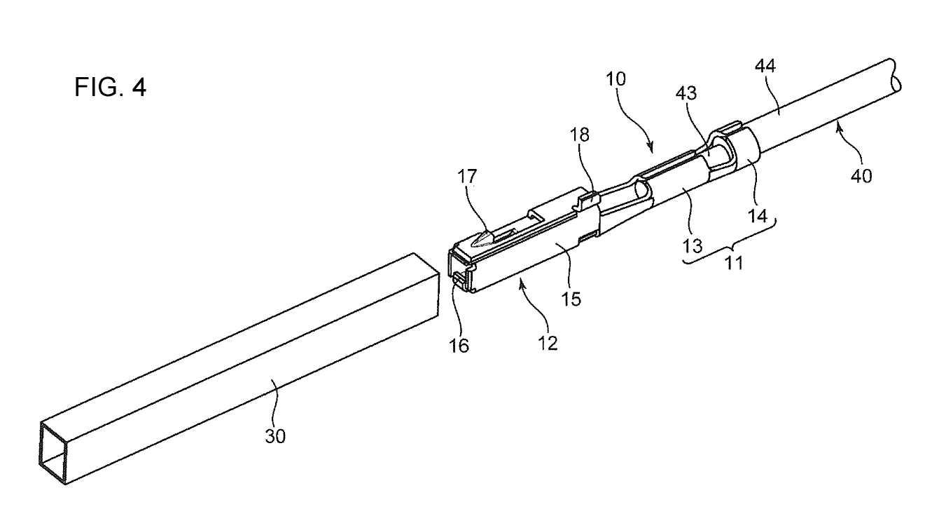

Each of the female terminals 10, including the terminals to be shielded, is formed by bending a single metal plate and, as shown in FIGS. 3 and 4, integrally includes a wire crimping portion 11 to be crimped to the end of the wire 40 and a female electrical contact portion 12 capable of contacting a mating male terminal shown in FIG. 2.

The wire crimping portion 11 includes a conductor barrel 13 and an insulation barrel 14 located behind the conductor barrel 13. The wire 40 includes a center conductor 43 and an insulation coating 44 covering the center conductor 43. An end part of the insulation coating 44 is removed to expose an end of the center conductor 43. The conductor barrel 13 is crimped to the end of the center conductor 43 and the insulation barrel 14 is crimped to a part of the insulation coating 44 adjacent to the end of the center conductor 43.

A part of the terminal to be shielded that is to be mounted on the end of the corresponding wire is not limited to the wire crimping portion. For example, the terminal to be shielded may include a wire insulation displacement portion instead of the wire crimping portion 11, i.e. may include a pressure contact blade capable of cutting the insulation coating 44 of the wire 40 and contacting the center conductor 43 of the wire 40.

The electrical contact portion 12 is configured to receive a male terminal 50 of the mating connector C2 shown in FIG. 2. Specifically, the electrical contact portion 12 includes a box-shaped body 15 into which the male terminal 50 can fit, and an electrical contact piece 16 is formed in the body 15. The electrical contact piece 16 is deflected resiliently and displaced in a direction perpendicular to a fitting direction by contacting the male terminal 50 fit into the body 15, and contacts the male terminal 50 with a spring pressure corresponding to this displacement. Thus, electrical conduction is formed between the female terminal 10 and the male terminal 50.

The body 15 is formed with a locked portion 17 to be locked (i.e. to be held) in the insulating housing 20 and a stabilizer 18 for preventing erroneous insertion. The locked portion 17 and the stabilizer 18 project out from an outer side surface of the body 15.

The insulating housing 20 is formed of an insulating material such as synthetic resin, and connects the female terminals 10 and the male terminals 50 included in the mating connector C2 by being fit into an insulating housing 60 of the mating connector C2 while holding the female terminals 10.

The insulating housing 20 includes terminal accommodating portions for accommodating and holding each of the female terminals 10. Specifically, the insulating housing 20 includes terminal accommodation chambers 22 and locking lances (terminal locking portions) 24 are provided in each of the terminal accommodation chambers 22.

The terminal accommodation chambers 22 are arranged in a direction perpendicular to an axial direction of the female terminals 10. Each terminal accommodation chamber 22 includes an opening on a side opposite to the male terminal 50 of the mating connector C2, and receives the corresponding female terminal 10 inserted therein through this opening. Specifically, each female terminal 10 is inserted into the terminal accommodation chamber 22 with the electrical contact portion 12 thereof in the lead and can be accommodated into the terminal accommodation chamber 22 over the entire length of the female terminal 10.

Each locking lance 24 locks the locked portion 17 of the female terminal 10 inserted into the terminal accommodation chamber 22 to prevent separation of the female terminal 10 from the terminal accommodation chamber 22. A terminal insertion hole 26 is formed in front of each terminal accommodation chamber 22 for allowing the insertion of the male terminal 50 to be connected to the female terminal 10.

A retainer 70 is mounted into the insulating housing 20 and secondarily locks each female terminal 10 locked by the locking lance 24 in each terminal accommodation chamber 22.

The shielding sheets 30 are mounted only on those female terminals 10 that are to be shielded. The shielding sheet 30 includes an insulating layer 32 and a conductive layer 34 to be laminated on this insulating layer 32 shown in FIG. 6. In FIG. 6, a thickness of the shielding sheet 30 is shown in a more exaggerated manner than it actually is. The insulating layer 32 is made of an insulating material and constitutes a base of the shielding sheet 30. This insulating layer 32, for example, can be constituted of PET. The conductive layer 34 constitutes a so-called shield shell made of an electrically conductive material. This conductive layer 34 can, for example, be formed of electrically conductive resin to be coated on the surface of the insulating layer 32.

The shielding sheet 30 is mounted on the female terminal 10 to cover a sheet mounting surface of one of the female terminals 20 to be shielded so that the insulating layer 32 of this shielding sheet 30 is held in close contact with the sheet mounting surface. In this way, a shielding structure in which the conductive layer 34 is formed around the outer surface of the female terminal 10 via the insulating layer 32 is constructed.

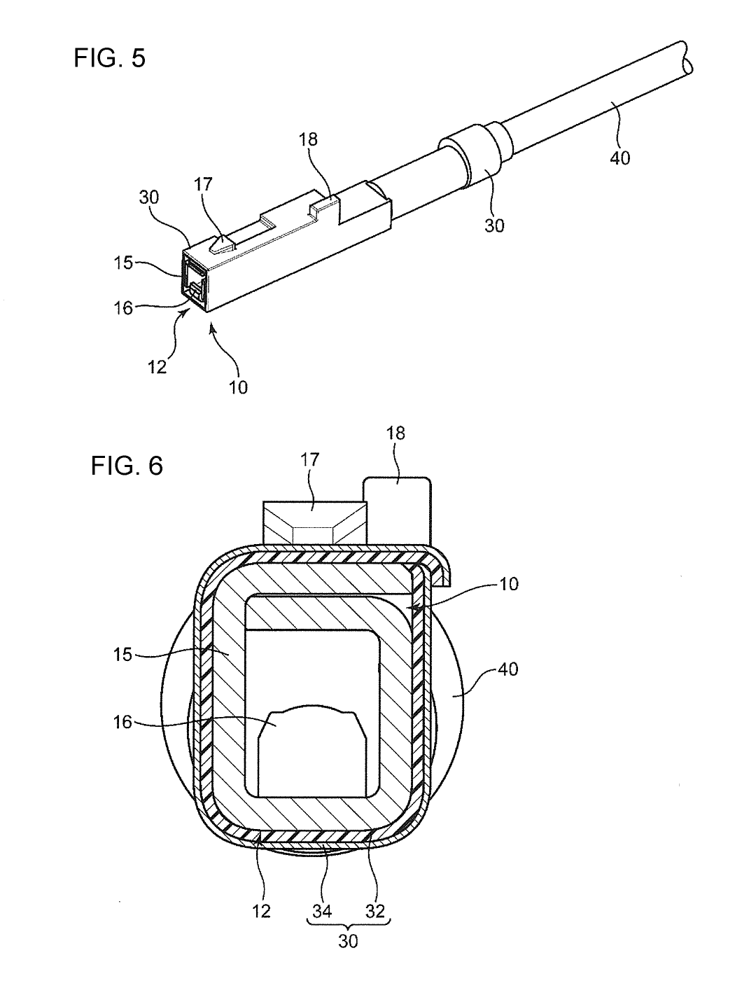

The thickness of the shielding sheet 30 can be set appropriately, but is preferably small enough to enable the terminal shielded with the shielding sheet 30 to be inserted into the terminal accommodation chamber 22 similarly to the other female terminals 10 regardless of the presence of the shielding sheet 30 and to allow the shielding sheet 30 to have such flexibility to be laid in conformity with the surface shape of the female terminal 10, as shown in FIGS. 1 and 5. Generally, a thickness of about 10 μm to 200 μm is preferable. However, the thickness of the shielding sheet according to the invention is not limited to such a dimension. In FIG. 6, the thickness of the shielding sheet 30 is larger than an actual thickness to clarify the presence of the shielding sheet 30.

An area As to be shielded by the shielding sheet 30 preferably is set in a range including the entire length of the female terminal 10, e.g. a range extending over the entire length of the female terminal 10 and the wire 40 behind the female terminal 10. The setting of this range enables a high electromagnetic shielding effect to be obtained.

According to the shield connector C1 described above, an effective shielding structure in which the conductive layer 34 is arranged on the sheet mounting surface via the insulating layer 32 is constructed by a simple configuration of merely mounting the shielding sheet 30 on the sheet mounting surface set on the terminal 10 requiring electromagnetic shielding. In addition, since this shielding sheet 30 has flexibility to be laid in conformity with the outer shape of the sheet mounting surface, the female terminal 10 equivalent to the terminal to be shielded can be accommodated into the terminal accommodation chamber 22 of the insulating housing 20 and held (locked) by the locking lance 24 at the locked portion 17 thereof similarly to the female terminals 10 mounted on this female terminal 10 that are not to be shielded. Thus, unlike conventional shield connectors in which a shielding layer is provided on an insulating housing, this shield connector C1 is not enlarged even though the above-described electromagnetic shielding function is given.

Further, the shielding sheets 30 are used for individually covering only the terminals to be shielded and not the female terminals 10 that are not to be shielded. Thus, the shielding sheets 30 for constituting shielding layers are not used wastefully. In the conventional shield connectors, the entire insulating housing for holding all of terminals needs to be covered with the shielding layer regardless of whether or not some of the terminals need not be shielded. However, the shielding sheets 30 in the above-described shield connector C1 can be mounted only on those female terminals 30 to be shielded, which enables a reduction in the amount of the shielding sheets used.

Further, the above shield connector C1 can be manufactured by a simple method of only adding a step of mounting the shielding sheet 30 to a manufacturing method for conventional connectors. Specifically, this shield connector C1 can be manufactured by: preparing the female terminals 10 and the insulating housing 20, mounting the female terminals 10 respectively on the ends of the wires 40, mounting the shielding sheet 30 such that the insulating layer 32 is held in close contact with the sheet mounting surface to cover the sheet mounting surface set for the terminal to be shielded out of the plurality of female terminals 10, and inserting the female terminals 10 into the terminal accommodation chambers 22 of the insulating housing 20 and locking the female terminals 10 by the locking lances 24. In this method, the shielding sheet 30 is thin and has flexibility to be laid in conformity with the outer shape of the sheet mounting surface of the female terminal 10 serving as the terminal to be shielded. Thus, the female terminal 10 to be shielded can be inserted into the terminal accommodation chamber 22 similarly to the other female terminals 10 with the shielding sheet 30 mounted thereon, and held by the locking lance 24. Thus, no special operation other than the mounting of the shielding sheet 30 is required.

The invention is not limited to the embodiment described above, and includes, for example, the following modes.

The terminal to be shielded is not limited to the female terminal and the male terminal can also be set as a terminal to be shielded. However, in this case, the sheet mounting surface cannot be set on a surface of the electrical contact portion involved in the contact with the mating female terminal, whereas the outer surface of the electrical contact portion can also be set as the sheet mounting surface in the female terminal. This provides an advantage of obtaining a good electromagnetic shielding effect also for a fit part of the terminals. Alternatively, the sheet mounting surfaces may be set on both the female terminal and the male terminal.

The wire on which the terminal to be shielded according to the present invention is mounted is not limited to the wire constituting the twisted pair cable as described above. The terminal to be shielded according to the present invention may be mounted on an end of another wire, e.g. a wire accommodated inside a shielding layer in a shielded cable including the shielding layer.

Specific structures of the terminals including the terminals to be shielded and the terminal accommodating portions of the housing for holding the terminals are not limited. Further, at least one of the terminals may be the terminal to be shielded and a specific number of the terminals to be shielded is not limited. For example, all of the plurality of terminals may be terminals to be shielded.

As described above, the shield connector and the manufacturing method therefor can provide necessary electromagnetic shielding without causing the enlargement of the entire connector.

1. A shield connector having an electromagnetic shielding function of shielding noise caused by electromagnetic waves from outside, comprising:
a plurality of terminals to be respectively mounted on ends of a plurality of wires, the terminals including at least one terminal to be shielded;
an insulating housing made of an insulating material and including a plurality of terminal accommodating portions for respectively accommodating and holding the plurality of terminals; and
a shielding sheet to be mounted on the terminal to be shielded to cover a sheet mounting surface set for at least a part of a surface of the terminal to be shielded excluding a part to be brought into contact with a mating terminal, the shielding sheet having the electromagnetic shielding function,
wherein:
the shielding sheet includes an insulating layer made of an insulating material and a conductive layer made of an electrically conductive material and to be laminated on the insulating layer, is mounted on the terminal to be shielded with the insulating layer held in close contact with the sheet mounting surface, and has flexibility to be laid in conformity with an outer shape of the sheet mounting surface; and
the terminal to be shielded is accommodated and held in the terminal accommodating portion with the sheet mounting surface covered by the shielding sheet.

2. The shield connector of claim 1, wherein the plurality of terminals include the at least one terminal to be shielded and the terminal other than the terminal to be shielded, and the shielding sheet is mounted only on the terminal to be shielded out of the plurality of terminals.

3. The shield connector of claim 1, wherein the at least one terminal to be shielded includes a wire crimping portion to be crimped to the end of the wire.

4. The shield connector of claim 1, wherein the at least one terminal to be shielded includes a female terminal having a female electrical contact portion for receiving an electrical contact portion of a mating male terminal fit thereinto, and an outer side surface of the electrical contact portion in the female terminal is included in the sheet mounting surface.

5. The shield connector of claim 4, wherein the sheet mounting surface is set over the entire length of the female terminal.

6. The shield connector of claim 1, wherein the at least one terminal to be shielded includes a terminal to be mounted on an end of a wire of a twisted pair cable including a pair of wires twisted with each other.

7. A method for manufacturing a shield connector having an electromagnetic shielding function of shielding noise caused by electromagnetic waves from outside, comprising:
preparing terminals including at least one terminal to be shielded and an insulating housing having terminal accommodating portions for respectively accommodating and holding the plurality of terminals;
respectively mounting the terminals on ends of wires;
mounting a shielding sheet having the electromagnetic shielding function on the terminal to be shielded to cover a sheet mounting surface set for at least a part of a surface of the terminal to be shielded excluding a part to be brought into contact with a mating terminal, the shielding sheet including an insulating layer made of an insulating material and a conductive layer made of a conductive material and to be laminated on the insulating layer, the shielding sheet having flexibility to be laid in conformity with an outer shape of the sheet mounting surface, the shielding sheet being mounted on the terminal to be shielded with the insulating layer held in close contact with the sheet mounting surface; and
respectively inserting and holding the terminal to be shielded in the terminal accommodating portion with the sheet mounting surface covered by the shielding sheet.
